(19) United States
(12) Patent Application Publication
(10) Pub. No.: US 2007/0190279 A1
(43) Pub. Date: Aug. 16, 2007

(54) Wrapping foil made of polypropylene copolymer and a polymer that is incompatible with polypropylene

(75) Inventors: Bernhard Mussig, Seevetal (DE); Ingo Neubert, Norderstedt (DE)

Correspondence Address: NORRIS, MCLAUGHLIN & MARCUS, P.A., 875 THIRD AVE, 18TH FLOOR, NEW YORK, NY, 10022, US

(73) Assignee: tesa AG, Hamburg (DE)

(21) Appl. No.: 10/574,685

(22) PCT Filed: Sep. 16, 2004
(86) PCT No.: PCT/EP04/52210

§ 371 Date: Apr. 16, 2007

(30) Foreign Application Priority Data
Oct. 14, 2003 (DE) 103 48 479.5

(51) Int. Cl. B32B 33/00; B32B 9/00

(52) U.S. Cl. 428/40.1; 428/41.8

(57) ABSTRACT

Flame-retardant, halogen-free winding film comprising at least one polypropylene copolymer, at least one inorganic flame retardant, and 1 to 30 phr, preferably 5 to 15 phr, of at least one polymer which is incompatible with the polypropylene copolymer.

The present invention relates to a filled, soft, halogen-free, flame-resistant winding film which is made from polypropylene copolymer and a polymer incompatible with polypropylene and which is used for wrapping, for example, ventilation lines in air-conditioning units or wires or cables, and in particular for cable looms in vehicles or field coils for picture tubes, and which has been optionally provided with a pressure-sensitive adhesive coating. This winding film serves for bundling, insulating, marking, sealing or protecting. The invention further embraces processes for producing the film of the invention.

Cable winding tapes and insulating tapes are normally composed of plasticized PVC film with a coating of pressure-sensitive adhesive on one side. There is an increased desire to eliminate the disadvantages of these products. These disadvantages include plasticizer evaporation, high halogen content and low thermal stability.

The plasticizers in conventional PVC insulating tapes and PVC cable winding tapes gradually evaporate, leading to a health hazard; the commonly used DOP, in particular, is objectionable. Moreover, the vapors deposit on the glass in motor vehicles, impairing visibility (and hence, to a considerable extent, driving safety), this being known to the skilled worker as fogging (DIN 75201). In the event of even greater vaporization as a result of higher temperatures, in the engine compartment of vehicles, for example, or in electrical equipment in the case of insulating tapes, the winding film is embrittled by the accompanying loss of plasticizer.

Plasticizers impair the fire performance of unadditized PVC, something which is compensated in part by adding antimony compounds, which are highly objectionable from the standpoint of toxicity, or by using chlorine- or phosphorus-containing plasticizers.

Against the background of the debate concerning the incineration of plastic wastes, such as shredder waste from vehicle recycling, for example, there exists a trend toward reducing the halogen content and hence the formation of dioxins. In the case of cable insulation, therefore, the wall thicknesses are being reduced, and the thicknesses of the PVC film are being reduced in the case of the tapes used for wrapping. The standard thickness of the PVC films for winding tapes is 85 to 200 μm. Below 85 μm, considerable problems arise in the calendering operation, with the consequence that virtually no such products with reduced PVC content are available.

The customary winding tapes comprise stabilizers based on toxic heavy metals, usually lead, more rarely cadmium or barium.

State of the art for the bandaging of sets of leads are winding films with and without an adhesive coating, said films being composed of a PVC carrier material which has been made flexible through incorporation of considerable amounts (30 to 40% by weight) of plasticizer. The carrier material is coated usually on one side with a self-adhesive mass based on SBR rubber. Considerable deficiencies of these adhesive PVC winding tapes are their low aging stability, the migration and evaporation of plasticizer, their high halogen content, and a high smoke gas density in the event of fire.

JP 10 001 583 A1, JP 05 250 947 A1, JP 2000 198 895 A1 and JP 2000 200 515 A1 describe typical plasticized PVC adhesive tapes. In order to obtain higher flame retardancy in the platicized PVC materials it is usual, as described for example in JP 10 001 583 A1, to use the highly toxic compound antimony oxide.

In addition, PVC is coming up against the limits of the present-day requirements in terms of thermal stability. Winding films are nowadays produced on the commercial scale exclusively by calendaring. Given new materials, it would also be possible to utilize extrusion, which would make the production operation less expensive, reduce layer thicknesses, and make the film, as a result of multilayer construction (coextrusion), more versatile.

In modern-day vehicle construction, on the one hand the cable harnesses are becoming more and more thick and rigid as a result of the multiplicity of electrical consumers and the increased transfer of information within vehicles, while on the other hand the space for their installation is becoming ever more greatly restricted, and, consequently, assembly (guidethrough when laying cables within the vehicle body) is becoming more problematic. As a result, a thin film tape is advantageous. Moreover, for efficient and cost-effective cable-harness production, cable winding tapes are expected to have easy and quick processing qualities.

There are attempts to use wovens or nonwovens instead of plasticized PVC film; however the products resulting from such attempts are but little used in practice, since they are relatively expensive and differ sharply from the habitual products in terms of handling (for example, hand tearability, elastic resilience) and under service conditions (for example, resistance to service fluids, electrical properties), with—as set out below—particular importance being attributed to the thickness.

DE 200 22 272 U1, EP 1 123 958 A1 and WO 99/61541 A1 describe adhesive winding tapes comprising a clothlike (woven) or weblike (nonwoven) carrier material. These materials are distinguished by a very high tensile strength. A consequence of this, however, is the disadvantage that, when being processed, these adhesive tapes cannot be torn off by hand without the assistance of scissors or knives.

Stretchability and flexibility are two of the major requirements imposed on adhesive winding tapes, in order to allow the production of crease-free, flexible cable harnesses. Moreover, these materials do not meet the relevant fire protection standards such as FMVSS 302. Improved fire properties can be realized only with the use of halogenated flame retardants or polymers as described in U.S. Pat. No. 4,992,331 A1.

Thermoplastic polyester are likewise being used on a trial basis for producing winding films and cable insulation. They have considerable deficiencies in terms of their flexibility, processing qualities, hand tearability, aging stability or compatibility with the cable materials. The gravest disadvantage of polyester, however, is its considerable sensitivity to hydrolysis, which rules out use in automobiles on safety grounds. DE 100 02 180 A1, JP 10 149 725 A1, JP 09 208 906 A1 and JP 05 017 727 A1 describe the use of halogen-free thermoplastic polyester carrier films.

Also described in the patent literature are winding tapes comprising polyolefins. These, however, are readily flammable or comprise halogenated flame retardants. Furthermore, the materials prepared from ethylene copolymers have too low a softening point (in general they melt even during an attempt to test them for stability to thermal aging), and in the case of the use of polypropylene polymers the material is too inflexible.

WO 00/71634 A1 describes an adhesive winding tape whose film is composed of an ethylene copolymer base material. The carrier film comprises the halogenated flame retardant decabromodiphenyl oxide. The film softens below a temperature of 95° C., but the normal service temperature is often above 100° C. or even briefly above 130° C., which is not unusual in the case of use in the engine compartment.

WO 97/05206 A1 describes a halogen-free adhesive winding tape whose carrier film is composed of a polymer blend of low-density polyethylene with an ethylene/vinyl acetate or ethylene/acrylate copolymer. The flame retardant used is 48 to 90 phr by weight of aluminum hydroxide. A considerable disadvantage of the carrier film is, here too, the low softening temperature owing to the polymer blend of polyethylene and ethylene/vinyl acetate copolymer. To counter the problem the use of silane crosslinking is described. This crosslinking method is complex and leads in practice only to material with very nonuniform crosslinking, so that it is not possible to realize a stable production operation or uniform product quality.

Similar problems of deficient heat distortion resistance and poor hand tearability occur with the electrical adhesive tapes described in WO 99/35202 A1 and U.S. Pat. No. 5,498,476 A. The carrier film material described is a blend of EPDM and EVA in combination with ethylenediamine diphosphate as flame retardant. Like ammonium polyphosphate, this flame retardant is highly sensitive to hydrolysis. In combination with EVA, moreover, there is an embrittlement on aging. Application to standard cables of polyolefin and aluminum hydroxide or magnesium hydroxide results in poor compatibility. Furthermore, the fire performance of such cable harnesses is poor, since these metal hydroxides act antagonistically with phosphorus compounds, as set out below. The insulating tapes described are too thick and too rigid for cable hardness winding tapes.

Attempts to resolve the dilemma between excessively low softening temperature and flexibility and freedom from halogen are described by the patents below.

EP 0 953 599 A1 claims a polymer blend of LLDPE and EVA for applications as cable insulation and as film material. The flame retardant described comprises a combination of magnesium hydroxide of specific surface area and red phosphorus; however, softening at a relatively low temperature was not solved.

A combination of polyolefin and EVA is described in EP 1 097 976 A1. In this case, instead of LLDPE, a PP polymer is used. The core idea is to attain certain mechanical properties at 100° C. through the PP polymer, which means in concrete terms that the problem of lack of heat distortion resistance of blends of polyethylene homopolymer and polyethylene copolymer is to be solved. The result is a low flexibility. This disadvantage of the invention can also be confirmed by measurements on the reworked examples. The third component of the blend (alongside PP copolymer and flame retardant) is EVA or EEA; this serves to improve the flame retardancy of combinations of polyethylene or polypropylene and filler, as the skilled worker is aware from the literature and as may be ascertained from the LOI values of the examples. Owing to their composition, these films are hard and inflexible. Testing of the force in machine direction at 1% elongation produces values, when the examples are reworked, of more than 10 N/cm. In the art, in the case of the PVC winding films presently employed, products with a value of around 1 N/cm have become established. This underlines the fact that for practical service these films are too inflexible. In the case of the reworked example, tearing into the film by hand is possible only with substantial force applied. Consequently, in spite of the improvement in heat distortion resistance, there is no solution to a problem, and hence in the present invention values of only 0.6 to 5 N/cm are aimed at. The products described have a film thickness of 0.2 mm: this thickness alone rules out flexibility in the case of filled polyolefin films, since flexibility is dependent on the thickness to the 3rd power. With the extremely low melt indices of the polypropylenes used, the described process of extrusion is virtually impossible to carry out on a production extrusion installation, and especially not for a thin film of 100 μm or less in conformity to the art, and certainly not in the case of use in the combination with the high amounts of platelet-shaped, finely divided filler that are described. The combination with sharply viscosity-increasing red phosphorus further hinders processing. Consequently, despite massive demand on the part of the Japanese automotive industry, the products have not acquired mature line status.

The attempted solution from the cited publications builds on the known synergistic flame retardancy effect of red phosphorus with magnesium hydroxide. The use of elemental phosphorus, however, harbors considerable disadvantages. In the course of processing, highly toxic phosphine is released. A further disadvantage arises from the development of very dense white smoke in the event of fire. Moreover, only brown to black products can be produced, whereas for color marking winding films are used in a broad color range.

The cited publications of the prior art, despite the specified disadvantages, do not set out films which also achieve the further requirements such as hand tearability, thermal stability, compatibility with polyolefin cable insulation, or adequate unwind force. Furthermore, the processing qualities in film production operations, the high fogging number, and the breakdown voltage resistance remain questionable.

The object of the invention remains to discover a solution for a winding film which combines the advantages of the flame retardancy, abrasion resistance, voltage resistance and mechanical properties (such as elasticity, flexibility, and hand tearability) of PVC winding tapes with the freedom from halogen of textile winding tapes and, furthermore, exhibits superior thermal aging resistance, in tandem with the needs to ensure that the film can be produced industrially and that it has a high breakdown voltage resistance and a high fogging number in the case of certain applications.

It is a further object of the invention to provide soft, halogen-free, flame-retardant winding films which allow particularly reliable and rapid wrapping, particularly of wires and cables, for the purpose of marking, protecting, insulating, sealing or bundling, where the disadvantages of the prior art do not occur, or else not to the same extent.

In concert with the increasingly complex electronics and the increasing number of electrical consumer units in automobiles, the sets of leads, too, are becoming ever more complex. With increasing cable harness cross sections, the inductive heating is becoming greater and greater, while the removal of heat is decreasing. As a result there are increases in the thermal stability requirements of the materials used. The PVC materials used as standard for adhesive winding tapes are reaching their limits here. A further object is therefore to find polypropylene copolymers with additive combinations which not only match but indeed exceed the hand tearability of PVC.

This object is achieved by means of a winding film as specified in the main claim. The dependent claims relate to advantageous developments of the winding film of the invention, to the use of the winding film in a soft, flame-retardant adhesive tape, to further applications thereof, and to processes for producing the winding film.

The invention accordingly provides a flame-retardant, halogen-free winding film comprising
at least one polypropylene copolymer,
at least one inorganic flame retardant, and
1 to 30 phr, preferably 5 to 15 phr, of at least one polymer which is incompatible with the polypropylene copolymer.

The amounts below in phr denote parts by weight of the component in question per 100 parts by weight of all polymer components of the film.

In the case of a winding film with coating (with adhesive, for example) only the parts by weight of all polymer components of the polyolefin-containing layer are taken into account.

The thickness of the film of the invention is advantageously in the range from 30 to 180 μm, preferably 50 to 150 μm, in particular 55 to 100 μm. The surface may be textured or smooth. Preferably the surface is made slightly matt. This can be achieved through the use of a filler having a sufficiently high particle size or by means of a roller (for example, embossing roller on the calendar or matted chill roll or embossing roller during extrusion).

In a preferred version the film is provided on one or both sides with a pressure-sensitively, adhesive layer, in order to simplify application, so that there is no need to fasten the winding film at the end of the winding operation.

Unforeseeably and surprisingly for the skilled worker a winding film of the invention can be produced from a polypropylene copolymer, from flame-retardant fillers and from a polymer incompatible with polypropylene copolymer. Remarkably, in addition, the thermal aging stability, in comparison to PVC as a high-performance material, is not poorer but instead is comparable or even better.

The winding film of the invention has in machine direction a force at 1% elongation of 1 to 4 N/cm and at 100% elongation a force of 2 to 20 N/cm, preferably of 3 to 15 N/cm.

In particular the force at 1% elongation is greater than or equal to 1 N/cm and the force at 100% elongation is less than or equal to 15 N/cm. The 1% force is a measure of the rigidity of the film, and the 100% force is a measure of the conformability when it is wound with sharp deformation as a result of high winding tension. The 100% force must also not be too low, since otherwise the tensile strength is inadequate.

In order to achieve these force values the winding film preferably comprises a soft polypropylene copolymer having a flexural modulus of less than 500 MPa, particularly preferably 80 MPa or less, and in particular 30 MPa or less. A homopolymer mixed with a soft polyolefin may, however, also be used.

The crystalline region of the copolymer is preferably a polypropylene having a random structure, in particular with an ethylene content of 6 to 10 mol %. A polypropylene random copolymer modified (with ethylene, for example) has a crystallite melting point, depending on the block length of the polypropylene and the comonomer content of the amorphous phase, of between 100° C. and 145° C. (this is the range for commercial products). Depending on molecular weight and tacticity, a polypropylene homopolymer is situated at between 163° C. to 166° C. If the homopolymer has a low molecular weight and has been modified with EP rubber (for example grafting, reactor blend), then the reduction in melting point leads to a crystallite melting point in the range from about 148° C. to 163° C.

For the polypropylene copolymer of the invention, therefore, the preferred crystallite melting point is below 145° C. and is best achieved with a comonomer-modified polypropylene having random structure in the crystalline phase and copolymeric amorphous phase.

In such copolymers, there is a relationship between the comonomer content of both the crystalline phase and the amorphous phase, the flexural modulus, and the 1% tension value of the winding film produced therefrom. A high comonomer content in the amorphous phase allows a particularly low 1% force value. Surprisingly, the presence of comonomer in the hard crystalline phase as well has a positive effect on the flexibility of the filled film.

The crystallite melting point ought, however, not to be below 120° C., as is the case for EPM and EPDM, since in the event of applications on ventilation pipes, screen coils or vehicle cables there is a risk of melting. Winding films comprising ethylene-propylene copolymers from the classes of the EPM and EPDM are therefore not in accordance with the invention, although this does not rule out using such polymers to fine-tune the mechanical properties alongside the polypropylene copolymer of the invention.

There are no restrictions imposed on the comonomers of the propylene polymer, although preference is given to using α-olefins such as ethylene, 1-butylene, isobutylene, 4-methyl-1-pentene, hexene or octene. Copolymers having three or more comonomers are included for the purposes of this invention. Particularly preferred as monomers for the polypropylene copolymer is ethylene. The polymer may additionally have been modified by grafting, for example with maleic anhydride or acrylate monomers, for the purpose of improving the processing properties or mechanical properties, for example. By a polypropylene copolymer is meant not only copolymers in the strict sense of polymer physics, such as block copolymers, for example, but also commercially customary thermoplastic PP elastomers with a wide variety of structures or properties. Materials of this kind may be prepared, for example, from PP homopolymers or random copolymers as a precursor by further reaction with ethylene and propylene in the gas phase in the same reactor or in subsequent reactors. When random copolymer starting material is used the monomer distribution of ethylene and propylene in the EP rubber phase which forms is more uniform, leading to improved mechanical properties. This is another reason why a polymer with a crystalline random copolymer phase is preferred for the winding polymer of the invention. For the preparation it is possible to employ conventional processes, examples including the gas-phase process, Cataloy process, Spheripol process, Novolen process, and Hypol process, which are described in Ullmann's Encyclopedia of Industrial Chemistry, 6th ed., Wiley-VCH 2002.

Suitable blend components are, for example, soft ethylene copolymers such as LDPE, LLDPE, metallocene-PE, EPM or EPDM with a density of 0.86 to 0.92 g/cm³, preferably from 0.86 to 0.88 g/cm³. Soft hydrogenated random or block copolymers of ethylene (unsubstituted or substituted) styrene and butadiene or isoprene are also suitable for bringing the flexibility, the force at 1% elongation, and, in particular, the shape of the force/elongation curve of the winding film into the optimum range. If in addition to the polypropylene polymer of the invention a further ethylene or propylene copolymer is used it preferably has a specified melt index in the range of ±50% of the melt index of the polypropylene polymer. This is without taking into account the fact that the melt index of ethylene copolymers is generally specified for 190° C. and not, as in the case of polypropylene, for 230° C.

The problem of poor tearability of the carrier film and the associated increase in the complexity of the winding operation is achieved in the underlying invention through the addition of at least one polymer which is incompatible with the polypropylene copolymer. This incompatible polymer produces predetermined breakage points in the micrometer range within the carrier film, which allows the winding film to be torn into easily by hand, without the usual formation of a very long, fibrillated torn-off edge. In spite of the increased tearability, surprisingly, the mechanical properties such as flexibility and tensile strength are not adversely affected by the incompatible polymer.

Highly polar polymers are considered by the skilled worker to be incompatible with polypropylene. By incompatible polymers is meant that the polymers form two polymer phases. This second phase is evident, for example, through electron micrographs, DSC (differential scanning calorimetry/differential thermoanalysis) or dynamomechanical measurements. An externally visible, apparently homogeneous miscibility should not be employed as a measure of the compatibility. Incompatibility or nonmiscibility of polymers is likewise reflected in the difference in solubility parameters (Hildebrand parameters). If the solubility parameter a of a polymer is at least 19 J 112/cm³¹², that polymer is incompatible with the polypropylene (co)polymer. Solubility parameters and their description are found in, among other sources, “Polymer Handbook”, 4th edition, Wiley & Son or “Properties of Polymers”, van Krevelen; Elsevier Scientific Publishing Co., 1976.

Where the incompatible polymers of the invention contain olefinic comonomers such as ethylene, the level must be low enough in order to ensure incompatibility; preference is therefore given to polymers without olefinic comonomers.

Surprisingly, these highly polar polymers, such as oxygen-containing and nitrogen-containing polymers, prove particularly suitable for exerting a positive influence on the hand tearability of the winding film without at the same time impairing the mechanical properties such as flexibility and breaking elongation of the film. In addition, these oxygen-containing and nitrogen-containing polymers act synergistically in terms of their flame retardancy in blends with polyolefins and magnesium hydroxide.

In the present invention use is made of 1 to 30 phr and more preferably 5 to 15 phr of at least one polymer which is incompatible with the polypropylene polymer, examples of such incompatible polymers being polyamides and polyesters having a sufficiently low softening point (fitting in with the processing temperature of polypropylene), polyvinyl acetate, polyvinyl alcohol, polyvinyl butyral, vinyl acetate-vinyl alcohol copolymer, poly(meth)acrylates, polyethylene-vinyl alcohol, ethylene-vinyl acetate or polyurethanes, which may also have been crosslinked. They may also have a core-shell structure: for example, a core of polyacrylates of alcohols having 2 to 8 carbon atoms and a shell of polymethyl methacrylate. In particular, acrylate impact modifiers, which are prepared for modifying PVC, prove particularly suitable. Preference is given to poly(meth)acrylates, and especially polyvinyl acetate. Furthermore, by using polyvinyl acetate, improved wetting of the flame retardant magnesium hydroxide is achieved, surprisingly, and hence in processing the time taken to reach a homogeneous mixture is reduced. As a consequence of the resultant markedly reduced tendency for small holes and specks to form in the production process, a higher breakdown voltage of these film materials is observed as a result. In another preferred embodiment, dispersion powders based on vinyl acetate (for example, with a polyvinyl alcohol shell, as used as modifiers for plaster and cement products), since even in small amounts they produce a distinct improvement in the hand tearability and flame retardancy, with no substantial impairment of the flexibility of the winding film and, in spite of their polarity, no increase in the sticking of the melt to calender rolls or chill rolls.

The flame retardant used is synthetic or natural magnesium hydroxide. For improved compatibility with the polymer, the magnesium hydroxide has preferably been given a surface coating. Examples here are coatings with fatty acids or aminosilanes. Further flame retardants or fillers may be combined with the magnesium hydroxide. Preference is given to the combination of the specific magnesium hydroxide with nitrogen-containing flame retardants. Examples thereof are dicyandiamide, melamine cyanurate, and sterically hindered amines such as those, for example, from the class of the HA(L)S.

With magnesium hydroxide, red phosphorus acts synergistically and can therefore be used as well. It does, however, have disadvantages: it is not possible to produce colored products, but instead only black and brown products; compounding is accompanied by formation of phosphine, which necessitates protective measures in order to avoid a risk to health; and, in the event of fire, thick white smoke is produced. It is therefore preferred not to use red phosphorus and instead to increase the filler fraction or to use or add an oxygen-containing polymer.

The amount of magnesium hydroxide is preferably in the range from 70 to 200 phr and more preferably in the range from 110 to 150 phr.

The fire performance also depends very greatly on other factors:
adhesive coating
type of polyolefin
type and amount of carbon black and
other additives.

The amount of the magnesium hydroxide is therefore selected such that the winding film is flame-retardant, i.e., slow-burning or self-extinguishing. The flame spread rate of the adhesive-coated winding film in accordance with FMVSS 302 with a horizontal sample is preferably below 300 mm/min, preferably below 200 mm/min and more preferably below 70 mm/min; in one outstanding embodiment of the winding film it is self-extinguishing under these test conditions. The oxygen index (LOI) is preferably above 19%, in particular above 21%, and more preferably above 23%.

Further additives customary in the case of films, such as fillers, pigments, aging inhibitors, nucleating agents, impact modifiers or lubricants, et cetera, can be used for the production of the winding film. These additives are described for example in “Kunststoff Taschenbuch”, Hanser Verlag, edited by H. Saechtling, 28th edition or “Plastic Additives Handbook”, Hanser-Verlag, edited by H. Zweifel, 5th edition.

The main objective of the present invention is the absence of halogens and volatile plasticizers. As stated, the thermal requirements are going up, so that in addition, an increased resistance is to be achieved with respect to conventional PVC winding films or the PVC-free film winding tapes that are being trialed. The present invention is therefore described with reference to this in detail below.

The winding film of the invention advantageously has a heat stability of at least 105° C. after 3000 hours, which means that after this storage there is still a breaking elongation of at least 100%. The film ought further to have a breaking elongation of at least 100% after 20 days' storage at 136° C. (accelerated test) and/or a heat resistance of 170° C. (30 min). In one outstanding form with the antioxidants described and optionally also with a metal deactivator, 125° C. after 2000 hours or even 125° C. after 3000 hours are attained. Conventional PVC winding films based on DOP have a heat stability of 85° C., while high-performance products based on polymer plasticizer attain 105° C. (engine compartment).

Compatibility between winding film and the other cable-harness components, such as cable sheathing, plugs and fluted tubes, is likewise necessary and can likewise be achieved by adapting the formulas, particularly with respect to the additives. A negative example that may be recited is the combination of an unsuitable polypropylene winding film with a copper-stabilized polyamide fluted tube; in this case both the fluted tube and the winding film have undergone embrittlement after 3000 hours at 105° C.

In order to achieve effective aging stability and compatibility the use of the correct aging inhibitors is assigned a particular role. In this context it is also necessary to take account of the total amount of stabilizer, since in previous experiments on the production of such winding tapes aging inhibitors were used not at all or only at below 0.3 phr, as is also usually the case for the production of other films. In the preferred embodiment the winding tapes of the invention contain more than 0.3 phr and in particular more than 1 phr of antioxidant (not including any optional metal deactivator). In one preferred embodiment the fraction of secondary antioxidant is more than 0.3 phr. Stabilizers for PVC products cannot be transferred to polypropylene. Secondary antioxidants break down peroxides and are therefore used as part of aging inhibitor packages in the case of diene elastomers. Surprisingly it has been found that a combination of primary antioxidants (for example, sterically hindered phenols or C-radical scavengers) and secondary antioxidants (for example, sulfur compounds, phosphites or sterically hindered amines), it also being possible for both functions to be united in one molecule, achieves the stated object in the case of diene-free polyolefins such as polypropylene as well. Particularly preferred is the combination of primary antioxidant, preferably sterically hindered phenols having a molecular weight of more than 500 g/mol (especially>700 g/mol), with a phosphitic secondary antioxidant (particularly with a molecular weight>600 g/mol). Phosphites or a combination of primary and two or more secondary aging inhibitors have not been used to date in winding films comprising polypropylene copolymers. The combination of a low-volatility primary phenolic antioxidant and one secondary antioxidant each from the class of the sulfur compounds (preferably with a molecular weight of more than 400 g/mol, especially>500 g/mol) and from the class of the phosphites is suitable, and in this case the phenolic, sulfur-containing and phosphitic functions need not be present in three different molecules; instead, more than one function may also be united in one molecule.

The winding film of the invention is preferably pigmented, especially black. Coloring may be carried out in the base film, in the adhesive layer or in any other layer. The use of organic pigments or dyes in the winding film is possible, preference being given to the use of carbon black. The carbon black fraction is preferably at least 5 phr, in particular at least 10 phr, since surprisingly it proves to have a significant influence on the fire performance. As carbon black it is possible to use all of the types, such as gas black, acetylene black, thermal black, furnace black and lamp black, for example, preference being given to lamp black, despite the fact that furnace blacks are usual for the coloring of films. For optimum aging, preference is given to carbon black grades having a pH in the range from 6 to 8, in particular lamp black.

The winding film is produced on a calender or by extrusion such as, for example, in a blowing or casting operation. These processes are described for example in Ullmann's Encyclopedia of Industrial Chemistry, 6th ed., Wiley-VCH 2002. The compound comprising the main components or all of the components can be produced in a compounder or kneading apparatus (for example, a plunger compounder) or extruder (for example, a twin-screw or planetary roll extruder) and then converted into a solid form (granules, for example) which are then melted in a film extrusion unit or in an extruder, compounder or roll mill of a calender installation, and processed further. High amounts of filler produce slight inhomogeneities (defects) which sharply reduce the breakdown voltage. The mixing operation must therefore be performed thoroughly enough that the film manufactured from the compound attains a breakdown voltage of at least 3 kV/100 μm, preferably at least 5 kV/100 μm. It is preferred to produce compound and film in one operation. The melt is supplied from the compounder directly to an extrusion unit or a calender, but may if desired pass through auxiliary installations such as filters, metal detectors or roll mills. In the course of the production operation the film is oriented as little as possible, in order to achieve good hand tearability, low force value at 1% elongation, and low contraction.

The contraction of the winding film in machine direction after hot storage (30 minutes in an oven at 125° C., lying on a layer of talc) is less than 5%, preferably less than 3%.

The mechanical properties of the winding film of the invention are situated preferably in the following ranges:
breaking elongation in md (machine direction) from 300% to 1000%, more preferably from 500% to 800%,
breaking strength in md in the range from 4 to 15, more preferably from 5 to 8 N/cm, the film being cut to size using sharp blades in order to determine the data.

In the preferred embodiment the winding film is provided on one or both sides, preferably one side, with a sealing or pressure-sensitive adhesive coating, in order to avoid the need for the wound end to be fixed by means of an adhesive tape, wire or knot. The amount of the adhesive layer is in each case 10 to 40 g/m², preferably 18 to 28 g/m² (that is, the amount after removal of water or solvent, where necessary; the numerical values also correspond approximately to the thickness in μm). In one case with adhesive coating the figures given here for the thickness and for mechanical properties dependent on thickness refer exclusively to the polypropylene-containing layer of the winding film, without taking into account the adhesive layer or other layers which are advantageous in connection with adhesive layers. The coating need not cover the whole area, but may also be configured for partial coverage. An example that may be mentioned is a winding film with a pressure-sensitively adhesive strip at each of the side edges. This strip can be cut off to form approximately rectangular sheets, which are adhered to the cable bundle by one adhesive strip and are then wound until the other adhesive strip can be bonded to the reverse of the winding film. A hoselike envelope of this kind, similar to a sleeve form of packaging, has the advantage that there is virtually no deterioration in the flexibility of the cable harness as a result of the wrapping.

Suitable adhesives include all customary types, especially those based on rubber. Rubbers of this kind may be, for example, homopolymers or copolymers of isobutylene, of 1-butene, of vinyl acetate, of ethylene, of acrylic esters, of butadiene or of isoprene. Particularly suitable formulas are those based on polymers themselves based on acrylic esters, vinyl acetate or isoprene.

In order to optimize the properties it is possible for the self-adhesive mass employed to have been blended with one or more additives such as tackifiers (resins), plasticizers, fillers, flame retardants, pigments, UV absorbers, light stabilizers, aging inhibitors, photoinitiators, crosslinking agents or crosslinking promoters. Tackifiers are, for example, hydrocarbon resins (for example, polymers based on unsaturated C₅ or C₉ monomers), terpene-phenolic resins, polyterpene resins formed from raw materials such as α- or β-pinene, for example, aromatic resins such as coumarone-indene resins, or resins based on styrene or α-methylsytrene, such as rosin and its derivatives, disproportionated, dimerized or esterified resins, for example, such as reaction products with glycol, glycerol or pentaerythritol, for example, to name only a few, and also further resins (as recited, for example, in Ullmanns Enzylopadie der technischen Chemie, Volume 12, pages 525 to 555 (4th ed.), Weinheim). Preference is given to resins without easily oxidizable double bonds, such as terpene-phenolic resins, aromatic resins, and, with particular preference, resins prepared by hydrogenation, such as, for example, hydrogenated aromatic resins, hydrogenated hydrogenated polycyclopentadiene resins, hydrogenated rosin derivatives or hydrogenated terpene resins.

Examples of suitable fillers and pigments include carbon black, titanium dioxide, calcium carbonate, zinc carbonate, zinc oxide, silicates or silica. Suitable admixable plasticizers are, for example, aliphatic, cycloaliphatic and aromatic mineral oils, diesters or polyesters of phthalic acid, trimellitic acid or adipic acid, liquid rubbers (for example, nitrile rubbers or polyisoprene rubbers of low molecular mass), liquid polymers of butene and/or isobutene, acrylic esters, polyvinyl ethers, liquid resins and soft resins based on the raw materials of tackifier resins, lanolin and other waxes or liquid silicones. Examples of crosslinking agents include isocyanates, phenolic resins or halogenated phenolic resins, melamine resins and formaldehyde resins. Suitable crosslinking promoters are, for example, maleimides, allyl esters such as triallyl cyanurate, and polyfunctional esters of acrylic and methacrylic acid. Examples of aging inhibitors include sterically hindered phenols, which are known, for example, under the trade name Irganox™.

Crosslinking is advantageous, since the shear strength (expressed as holding power, for example) is increased and hence the tendency toward deformation in the rolls on storage (telescoping or formation of cavities, also called gaps) is reduced. Exudation of the pressure-sensitive adhesive mass, as well, is reduced. This is manifested in tack-free side edges of the rolls and tack-free edges in the case of the winding film wound spirally around cables. The holding power is preferably more than 150 min.

The bond strength to steel ought to be situated in the range from 1.5 to 3 N/cm.

In summary the preferred embodiment has on one side a solvent-free self-adhesive mass which has come about as a result of coextrusion, melt coating or dispersion coating. Dispersion adhesives are preferred, especially polyacrylate-based ones.

Advantageous is the use of a primer layer between winding film and adhesive mass in order to improve the adhesion of the adhesive mass on the winding film and hence to prevent transfer of adhesive to the reverse of the film during unwinding of the rolls.

Primers which can be used are the known dispersion- and solvent-based systems based for example on isoprene or butadiene rubber and/or cyclo rubber. Isocyanate or epoxy resin additives improve the adhesion and in part also increase the shear strength of the pressure-sensitive adhesive. Physical surface treatments such as flaming, corona or plasma, or coextrusion layers, are likewise suitable for improving the adhesion. Particular preference is given to applying such methods to solvent-free adhesive layers, especially those based on acrylate.

The reverse face can be coated with known release agents (blended where appropriate with other polymers). Examples are stearyl compounds (for example, polyvinyl stearylcarbamate, stearyl compounds of transition metals such as Cr or Zr, and ureas formed from polyethylenimine and stearyl isocyanate), polysiloxanes (for example, as a copolymer with polyurethanes or as a graft copolymer on polyolefin), and thermoplastic fluoropolymers. The term stearyl stands as a synonym for all linear or branched alkyls or alkenyls having a C number of at least 10, such as octadecyl, for example.

Descriptions of the customary adhesive masses and also reverse-phase coatings and primers are found for example in “Handbook of Pressure Sensitive Adhesive Technology”, D. Satas, (3rd edition). The stated reverse-phase primer coatings and adhesive coatings are possible in one embodiment by means of coextrusion.

The configuration of the reverse face of the film may also, however, serve to increase the adhesion of the adhesive mass to the reverse face of the winding film (in order to control the unwind force, for example). In the case of polar adhesives such as those based on acrylate polymers, for example, the adhesion of the reverse face to a film based on polypropylene polymers is often not sufficient. For the purpose of increasing the unwind force an embodiment is claimed in which the polar reverse-face surfaces are achieved by corona treatment, flame pretreatment or coating/coextrusion with polar raw materials. Claimed alternatively is a winding film in which the log product has been conditioned (stored under hot conditions) prior to slitting. Both processes may also be employed in combination. The winding film of the invention preferably has an unwind force of 1.2 to 6.0 N/cm, very preferably of 1.6 to 4.0 N/cm, and in particular 1.8 to 2.5 N/cm, at an unwind speed of 300 mm/min. The conditioning is known in the case of PVC winding tapes, but for a different reason. In contradistinction to partially crystalline polypropylene copolymer films, plasticized PVC films have a broad softening range and, since the adhesive mass has a lower shear strength, owing to the migrative plasticizer, PVC winding tapes tend toward telescoping. This unadvantageous deformation of the rolls, in which the core is forced out of the rolls to the side, can be prevented if the material is stored for a relatively long time prior to slitting or is subjected briefly to conditioning (storage under hot conditions for a limited time). In the case of the process of the invention, however, the purpose of the conditioning is to increase the unwind force of material with an apolar polypropylene reverse face and with a polar adhesive mass, such as polyacrylate or EVA, since this adhesive mass exhibits extremely low reverse-face adhesion to polypropylene in comparison to PVC. An increase in the unwind force by conditioning or physical surface treatment is unnecessary with plasticized PVC winding tapes, since the adhesive masses normally used possess sufficiently high adhesion to the polar PVC surface. In the case of polyolefin winding films the significance of reverse-face adhesion is particularly pronounced, since because of the higher force at 1% elongation (owing to the flame retardant and the absence of conventional plasticizers), a much higher reverse-face adhesion, and unwind force, is necessary, in comparison to PVC film, in order to provide sufficient stretch during unwind for the application. The preferred embodiment of the winding film is therefore produced by conditioning or physical surface treatment in order to achieve outstanding unwind force and stretch during unwind, the unwind force at 300 mm/min being higher preferably by at least 50% than without such a measure.

The winding film of the invention is outstandingly suitable for the wrapping of elongate material such as ventilation pipes in air-conditioning installation, field coils or cable looms in vehicles, since the high flexibility ensures good conformability to wires, cables, rivets, beads and folds.

Present-day occupational hygiene and environmental requirements are met, because halogenated raw materials are not used; the same also applies to volatile plasticizers, even though the amounts are so small that the fogging number is more than 90%. Absence of halogen is extremely important for the recovery of heat from wastes which includes such winding tapes (for example, incineration of the plastics fraction from vehicle recycling). The product of the invention is halogen-free in the sense that the halogen content of the raw materials is so low that it plays no part in the flame retardancy. Halogens in trace amounts, such as may occur as a result of impurities or as residues of catalysts (from the polymerization of polymers, for example) or as process auxiliaries, for example, fluorine elastomers, remain disregarded. The omission of halogens is accompanied by the quality of easy flammability, which is not in accordance with the safety requirements in electrical applications such as household appliances or vehicles. The deficient flexibility and the poor flame resistance when using customary PVC substitute materials such as polypropylene, polyethylene, polyesters, polystyrene, polyamide or polyimide for the winding film is solved by the use of a mixture of a soft polypropylene copolymer (with a low flexural modulus) and a flame retardant, preferably magnesium hydroxide. It is particularly surprising, therefore, that it is possible even to use fillers having a flame retardancy effect, which are known to impair the flexibility drastically to the point of complete embrittlement. The flexibility of a winding film is of crucial importance, however, since application to wires and cables requires not only spiral winding but also creaseless curve-flexible winding at branching points, plugs or fastening clips. Moreover, it is desirable for the winding film to draw the cable strand together elastically. This behavior is also needed for the sealing of ventilation pipes. These mechanical properties can be achieved only by a soft, flexible winding tape.

In addition to these requirements, the processing properties of the winding tapes also play a large part. Since the winding tapes are primarily processed by hand, economic reasons cause the processor to demand a winding film having a high flexibility and one which can easily be torn into by hand without assistance from tools such as scissors or knives.

The term “hand tearability” encompasses not only lateral tearing using two hands, between thumb and index finger, but also sharp torn severing in the lengthwise direction. As is familiar to the skilled worker, with films or with adhesive tapes produced from them, the simultaneous requirements for easy stretchability and easy hand tearability are irreconcilable. Expressed more simply, films are usually either soft and stretchable or brittle and hand-tearable. When producing the rolls of adhesive tape it is possible, in order to improve hand tearability, to produce rough cut edges which when viewed microscopically form cracks, which promote tear propagation. This is possible through the use of squeeze cutting with rotating knives which are blunted or have a defined serration, or by means of parting slitting with blunt fixed blades. This method of improving hand tearability is effective only, however, in the case of hard (brittle) or semi-hard films. With soft films, as in the case of the present invention, this method has virtually no effect on hand tearability.

When producing the rolls of adhesive tape it is usual, in order to improve hand tearability, to produce rough cut edges which, when viewed microscopically, form cracks, which promote tear propagation. This is possible through the use of squeeze cutting with rotating blades which are blunted or have a defined serration, or by parting slitting with blunt fixed blades. This method, however, is limited to hard and semi-hard carrier materials such as unplasticized PVC films or drawn polypropylene films. With highly flexible materials such as the winding films, in contrast, no satisfactory results are achieved.

### Test Methods

The measurements are carried out under test conditions of 23±1° C. and 50±5% relative humidity.

The tensile elongation behavior of the winding film is determined on type 2 test specimens (rectangular test strips 150 mm long and, as far as possible, 15 mm wide) in accordance with DIN EN ISO 527-3/2/300 with a test speed of 300 mm/min, a clamped length of 100 mm and a pretensioning force of 0.3 N/cm. In the case of specimens with rough slit edges, the edges should be tidied up with a sharp blade prior to the tensile test. In deviation from this, for determining the force or tension at 1% elongation, measurement is carried out with a test speed of 10 mm/min and a pretensioning force of 0.5 N/cm on a model Z 010 tensile testing machine (manufacturer: Zwick). The testing machine is specified since the 1% value may be influenced somewhat by the evaluation program. Unless otherwise indicated, the tensile elongation behavior is tested in machine direction (MD). The force is expressed in N/strip width and the tension in N/strip cross section, the breaking elongation in %. The test results, particularly the breaking elongation (elongation at break), must be statistically ascertained by means of a sufficient number of measurements.

The bond strengths are determined at a peel angle of 180° in accordance with AFERA 4001 on test strips which (as far as possible) are 15 mm wide. AFERA standard steel plates are used as the test substrate, in the absence of any other substrate being specified.

The thickness of the winding film is determined in accordance with DIN 53370. Any pressure-sensitive adhesive layer is subtracted from the total thickness measured.

The holding power is determined in accordance with PSTC 107 (10/2001), the weight being 20 N and the dimensions of the bond area being 20 mm in height and 13 mm in width.

The unwind force is measured at 300 mm/min in accordance with DIN EN 1944.

The hand tearability cannot be expressed in numbers, although breaking force, breaking elongation and impact strength under tension (all measured in machine direction) are of substantial influence.

Evaluation:

+++=very easy,

++=good,

+=still processable,

−=difficult to process,

=can be torn only with high application of force; the ends are untidy,

−=unprocessable

The fire performance is measured in accordance with MVSS 302 with the sample horizontal. In the case of a pressure-sensitive adhesive coating on one side, that side faces up. As a further method, testing of the oxygen index (LOI) is performed. Testing for this purpose takes place under the conditions of JIS K 7201.

The heat stability is determined by a method based on ISO/DIN 6722. The oven is operated in accordance with ASTM D 2436-1985 with 175 air changes per hour. The test time amounts to 3000 hours. Test temperatures chosen are 85° C. (class A), 105° C. (similar to class B but not 100° C.), and 125° C. (class C). Accelerated aging takes place at 136° C., with the test being passed if the elongation at break is still at least 100% after 20 days' aging.

In the case of compatibility testing, storage under hot conditions is carried out on commercially customary leads (cables) with polyolefin insulation (polypropylene or radiation-crosslinked polyethylene) for motor vehicles. For this purpose, specimens are produced from 5 leads with a cross section of 3 to 6 mm² and a length of 350 mm, with winding film, by wrapping with a 50% overlap. After the aging of the specimens in a forced-air oven for 3000 hours (conditions as for heat stability testing), the samples are conditioned at 23° C. and in accordance with ISO/DIN 6722 are wound by hand around a mandrel; the winding mandrel has a diameter of 5 mm, the weight has a mass of 5 kg, and the winding rate is 1 rotation per second. The specimens are subsequently inspected for defects in the winding film and in the wire insulation beneath the winding film. The test is failed if cracks can be seen in the wire insulation, particularly if this is apparent even before bending on the winding mandrel. If the winding film has cracks or has melted in the oven, the test is likewise classed as failed. In the case of the 125° C. test, specimens were in some cases also tested at different times. The test time is 3000 hours unless expressly described otherwise in an individual case.

The short-term thermal stability is measured on cable bundles comprising 19 wires of type TW with a cross section of 0.5 mm², as described in ISO 6722. For this purpose the winding film is wound with a 50% overlap onto the cable bundle, and the cable bundle is bent around a mandrel with a diameter of 80 mm and stored in a forced-air oven at 140° C. After 168 hours the specimen is removed from the oven and examined for damage (cracks).

To determine the heat resistance the winding film is stored at 170° C. for 30 minutes, cooled to room temperature for 30 minutes and wound with at least 3 turns and a 50% overlap around a mandrel with a diameter of 10 mm. Thereafter the specimen is examined for damage (cracks).

In the case of the low-temperature test at the above-described specimen is cooled to −40° C. for 4 hours, in a method based on ISO/DIS 6722, and the sample is wound by hand onto a mandrel with a diameter of 5 mm. The specimens are examined for defects (cracks) in the adhesive tape.

The breakdown voltage is measured in accordance with ASTM D 1000. The number taken is the highest value for which the specimen withstands this voltage for one minute. This number is converted to a sample thickness of 100 μm.

Example:

A sample 200 μm thick withstands a maximum voltage of 6 kV for one minute: the calculated breakdown voltage amounts to 3 kV/100 μm.

The fogging number is determined in accordance with DIN 75201 A.

The examples which follow are intended to illustrate the invention without restricting its scope.

Tabular compilation of the raw materials used for the experiments (the measurement conditions/units are in some cases omitted; see Test Methods)

| Raw material | Manufacturer | Description | Technical data |
|---|---|---|---|
| A 0750 | Union Carbide | Aminosilane | Crosslinker |
| Acronal DS 3458 | BASF | Acrylate PSA | Hotmelt PSA |
| Adflex KS 359 P | Basell | Ethylene-modified | Flexural modulus = 83 MPa, |
| | | polypropylene homo- | MFI = 12, |
| | | polymer | Tcr = 154° C., |
| | | | Density = 0.88, |
| | | | Breaking stress 10 MPa, |
| | | | Yield stress 5.0 MPa |
| | | | σ = 17.2 J^{1/2}/cm^{3/2} |
| Airflex EAF 60 | Air Products | EVA PSA | Dispersion PSA |
| AMEO T | Hüls AG | Aminosilane | Crosslinker |
| Antimony oxide TMS | Great Lakes | Diantimony trioxide | |
| Attane SL 4100 | Dow | ULDPE | D = 0.912; MFI = 1 |
| | | | σ = 16.1 J^{1/2}/cm^{3/2} |
| Baerostab UBZ 639 | Baerlocher | Stabilisator batch | |
| Brucite 15μ | Lehmann& | Ground magnesium | d₅₀ = 4 μm, |
| | Voss | hydroxide, | d₉₇ = 18 μm |
| | | | irregularly spherical, |
| | | | calcium carbonate 2.4%, |
| | | | 0.5% stearic acid |
| Carbon Black FEF | Shama | Furnace black | pH = 10 |
| | Chemical | | |
| Cataloy KS-021 P | SKD Sunrise | EP-modified PP | Flexural modulus = 228 MPa, |
| | | homopolymer, grafting | MFI = 0.9, |
| | | in the cataloy process | Tcr = 154° C., |
| | | | Density = 0.89, |
| | | | Breaking stress 12 MPa, |
| | | | Yield stress 6.9 MPa |
| Cataloy KS-353 P | SKD Sunrise | EP-modified PP | Flexural modulus = 83 MPa, |
| | | homopolymer, grafting | MFI = 0.45, |
| | | in the cataloy process | Tcr = 154° C., |
| | | | Density = 0.88, |
| | | | Breaking stress 10 MPa, |
| | | | Yield stress 6.2 MPa |
| DE 83 R | Great Lakes | Decabromodiphenyl | |
| | | oxide | |
| Desmodur Z 4470 | Bayer | Isocyanate | Crosslinker |
| MPA/X | | | |
| EDAP | Albright & | Ethylenediamine | |
| | Wilson | phosphate | |
| Elvax 470 | DuPont | EVA | VAc = 18%, MFI = 0.7 |
| | | | σ = 18.6 J^{1/2}/cm^{3/2} |
| Epsyn 7506 | Copolymer | EPDM rubber | σ = 16.9 J^{1/2}/cm^{3/2} |
| Escorene UL 00112 | Exxon | EVA | VAc = 12%, MFI = 1 |
| | | | σ = 18.2 J^{1/2}/cm^{3/2} |
| Escorene UL 00119 | Exxon | EVA | VAc = 19%, MFI = 1 |
| | | | σ = 18.6 J^{1/2}/cm^{3/2} |
| Escorene UL 02133 | Exxon | EVA | VAc = 33%, MFI = 21 |
| | | | σ = 18.6 J^{1/2}/cm^{3/2} |
| ESI DE 200 | Dow | Ethylene-styrene inter- | σ = 16.8 J^{1/2}/cm^{3/2} |
| | | polymer | |
| Evaflex A 702 | DuPont | EEA | EA = 19%, MFI = 5 |
| | | | σ = 18.6 J^{1/2}/cm^{3/2} |
| Evaflex P 1905 | DuPont | EVA | VAc = 19%, MFI = 5 |
| | | | σ = 18.7 J^{1/2}/cm^{3/2} |
| EVAL 105 B | EVAL | Polyethylene-vinyl | 44% ethylene, MFI = 5.5 |
| | | alcohol | σ = 19.1 J^{1/2}/cm^{3/2} |
| Evatane 1005 VN4 | Elf Atochem | EVA | VAc = 14%, MFI = 0.7 |
| | | | σ = 18.3 J^{1/2}/cm^{3/2} |
| Evatane 2805 | Elf Atochem | EVA | VAc = 28%, MFI = 5 |
| | | | σ = 18.8 J^{1/2}/cm^{3/2} |
| Flammruβ 101 | Degussa | Lamp black | pH = 7.5 |
| Irgafos 168 | Ciba-Geigy | Secondary antioxidant | Phosphite |
| Irganox 1010 | Ciba-Geigy | Primary antioxidant | Sterically hindered phenol |
| Irganox 1076 | Ciba-Geigy | Primary antioxidant | Sterically hindered phenol |
| Irganox MD 1024 | Ciba-Geigy | Metal deactivator | Heavy metal scavenger |
| Irganox PS 800 | Ciba-Geigy | Secondary antioxidant | Thiopropionic ester |
| Irganox PS 802 | Ciba-Geigy | Secondary antioxidant | Thiopropionic ester |
| JB 720 | Johnson | Acrylate PSA | Dispersion PSA |
| Kisuma 5 A | Kisuma | Precipitated magnesium | d₅₀ = 1.0 μm, |
| | | hydroxide | platelet-shaped |
| Levapren 450 | Beyer | EVA | VAc = 45% |
| | | | σ = 20.0 J^{1/2}/cm^{3/2} |
| Lupolex 18E FA | Basell | LLDPE | Density = 0.919, MFI = 0.5 |
| | | | σ = 16.1 J^{1/2}/cm^{3/2} |
| Luwax AL 3 | BASF | Lubricant | |
| Magnifin H 5 GV | Martinswerk | Precipitated magnesium | d₅₀ = 1.35 μm, |
| | | hydroxide | platelet-shaped, polymer coating |
| Magshizu N-3 | Konoshima | Precipitated magnesium | d₅₀ = 1.1 μm, |
| | Chemical | hydroxide | platelet-shaped, fatty acid coating |
| Martinal 99200-08 | Martinswerk | Aluminum hydroxide | Coating |
| Melapur MC 25 | DSM | Flame retardant | Melamine cyanurate |
| Novaexcel F-5 | Rinkagaku/ | Red phosphorus | |
| | Phosphorous | | |
| | Chemical | | |
| Pacrel 637 | Opatech | Crosslinked polyacrylate | σ = 21.2 J^{1/2}/cm^{3/2} |
| | | batched in PP | |
| PEG 6000 | Bayer | Polyethylene glycol | 6000 g/mol |
| | | | σ = 19.5 J^{1/2}/cm^{3/2} |
| Petrothene PM 92049 | Equistar | Furnace black | pH = 9, 40% furnace black in |
| | | masterbatch | polyethylene |
| Polymer A | | EP-modified random PP | Flexural modulus = 80 MPa, |
| | | copolymer from reactor | MFI = 0.6, |
| | | cascade, gas-phase | Tcr = 142° C., |
| | | process | Density = 0.88, |
| | | | Breaking stress 23 MPa, |
| | | | Yield stress 6 MPa |
| | | | σ = 17.1 J^{1/2}/cm^{3/2} |
| Polymer B | | EP-modified random PP | Flexural modulus = 80 MPa, |
| | | copolymer from reactor | MFI = 8, |
| | | cascade, gas-phase | Tcr = 142° C., |
| | | process | Density = 0.88, |
| | | | Breaking stress 16 MPa, |
| | | | Yield stress 6 MPa |
| | | | σ = 17.1 J^{1/2}/cm^{3/2} |
| Polymer C | | EP-modified random PP | Flexural modulus = 30 MPa, |
| | | copolymer from reactor | MFI = 0.6, |
| | | cascade, gas-phase | Tcr = 141° C., |
| | | process | Density = 0.87, |
| | | | Breaking stress 10 MPa |
| | | | σ = 16.8 J^{1/2}/cm^{3/2} |
| Primal PS 83D | Rohm & Haas | Acrylate PSA | Dispersion PSA |
| Raven PFEB | Polyplast | Carbon black | |
| | | masterbatch | |
| Rikidyne BDF 505 | Vig te Qnos | Acrylate PSA | Solution PSA |
| RTP 1800 | RTP | PMMA | σ = 20.2 J^{1/2}/cm^{3/2} |
| RTP 200 | RTP | Polyamide | Nylon 6/6 |
| | | | σ = 22.1 J^{1/2}/cm^{3/2} |
| Seast 3 H | Tokai Carbon | Furnace black | pH = 9.5 |
| SH 3 | Dow Chemical | Calcium carbonate | |
| | | masterbatch | |
| Tinuvin 622 LD | Ciba-Geigy | Light stabilizer | Hindered amine |
| Tuftec M-1943 | Asahi Chemical | Diene-styrene elastomer | σ = 16.7 J^{1/2}/cm^{3/2} |
| Ultranox 626 | GE | Primary antioxidant | Sterically hindered phenol |
| Vinnapas B 100 | Wacker | Polyvinyl acetate | σ = 20.9 J^{1/2}/cm^{3/2} |

### EXAMPLE 1

To produce the carrier film, 90 phr of polymer A, 10 phr of Vinnapas B 100, 160 phr of Magnifin H 5 GV, 10 phr of Flammruβ 101, 0.8 phr of Irganox 1010, 0.8 phr of Irganox PS 802 and 0.3 phr of Irgafos 168 are first compounded in a co-rotating twin-screw extruder. ⅓ of the Magnifin is added in each of zones 1, 3, and 5.

The compound melt is taken from the die of the extruder to a roll mill, from where it is passed through a strainer and subsequently fed via a conveyor belt into the nip of a calender of the “Inverted L” type. With the aid of the calender rolls, a film having a smooth surface is formed in a width of 1500 mm and a thickness of 0.08 nm (80 μm) and is post-crystallized on thermofixing rolls. The film is stored for one week, leveled on the coating installation with rolls at 60° C. in order to improve the planar lie, and, following corona treatment, is coated with an aqueous acrylate PSA, Primal PS 83 D, by means of a coating knife, with an application rate of 24 g/m². The layer of adhesive is dried in a drying tunnel at 70° C.; the finished winding film is wound to log rolls having a running length of 33 m on a 1-inch core (25 mm). Slitting takes place by parting the log rolls by means of a fixed blade with a not very acute angle (straight knife) into rolls 29 mm wide. As in the case of the subsequent examples as well, in the parting slitting an automatic device is used, for the reasons set out in the description of the invention.

In spite of the high filler fraction, this self-adhesive winding film exhibits good flexibility. The winding film is distinguished by very good processability and hand tearability. The aging stability and the compatibility with PP and PA cables and polyamide fluted tube are outstanding.

### EXAMPLE 2

The compound is produced on a pin extruder (Buss) without carbon black, with underwater granulation. After drying, the compound is mixed with the carbon black masterbatch in a mixer.

The carrier film is produced on a blown-film extrusion line, using the following formula: 75 phr of polymer B, 15 phr of Pacrel 637, 160 phr of Magnifin H 5 GV, 20 phr of a masterbatch of 50% Flammruβ 101 and 50% polyethylene, 0.8 phr of Irganox 1076, 0.8 phr of Irganox PS 800 and 0.2 phr of Ultranox 626.

The film bubble is slit and opened with a triangle to give a flat web, which is guided via a heat-setting station, corona treated on one side and stored for a week for post-crystallization. For leveling (improvement of the planar lie) the film is guided over 5 preheating rolls on the coating line, coating otherwise taking place with pressure-sensitive adhesive in the same way as in example 1 but additionally comprising 10% by weight of Melapur MC 25, and then the log rolls are conditioned at 65 C for 5 hours and slit as in example 1.

Without heat-setting, the film exhibits marked contraction (5% in width, length not measured) during the drying operation. The planar lie of the freshly produced film is good, and it is coated immediately after extrusion; unfortunately, after three weeks' storage at 23° C., the rolls have already undergone marked telescoping. This problem can also not be eliminated by conditioning the log rolls (10 hours at 70° C.).

The telescoping can be prevented by storage of the film for 1 week prior to coating and by winding of the coated film onto foam-clad cores.

The film is notable for excellent processing properties, including hand tearability, and also very good aging resistance.

### EXAMPLE 3

The preparation takes place as in example 1, with the following changes:

The compound is composed of 90 phr of polymer A, 10 phr of PEG 6000, 120 phr of Brucite 15μ, 15 phr of Flammruβ 101, 0.8 phr of Irganox 1010, 0.8 phr of Irganox PS 802, 0.3 phr of Irgafos 168 and 1 phr of Irganox MD 1024. ½ of the Brucite was added in each of zones 1 and 5:

The carrier film produced from this compound is subjected to flame pretreatment on one side and, after 10 days' storage, is coated with Acronal DS 3458 by means of a roll applicator at 50 m/min. The temperature load on the carrier is reduced by means of a cooled counterpressure roller. The application rate is about 35 g/m². Appropriate crosslinking is achieved in-line, before winding, by irradiation with a UV unit equipped with 6 medium-pressure Hg lamps each of 120 W/cm. The irradiated web is wound to form log rolls with a running length of 33 m on a 1¼-inch core (31 mm). For the purpose of increasing the unwind force, the log rolls are conditioned in an oven at 60° C. for 5 hours.

This winding film is distinguished by even greater flexibility than that from example 1. The fire spread speed is more than sufficient for the application. The film has a slightly matt surface. With respect to application, the winding tape can be manipulated and torn very easily by hand.

### EXAMPLE 4

Production takes place as in example 2, with the following changes:

the compound is composed of 80 phr of polymer A, 10 phr of Evaflex A 702, 10 phr of EVAL 105B, 160 phr of Kisuma 5A, 10 phr of Flammruβ 101, 0.8 phr of Irganox 1010, 0.8 phr of Irganox PS 802 and 0.3 phr of Irgafos 168.

The film is corona-treated upstream of the calender winding station and on this side of the adhesive mass Rikidyne BDF 505 is applied (with the addition of 1% by weight of Desmodur Z 4470 MPA/X per 100 parts by weight of adhesive mass, calculated on the basis of solids content) at 23 g/m². The adhesive is dried in a heating tunnel, in the course of which it is chemically crosslinked, and at the end of the dryer it is wound up into jumbo rolls, gently corona-treated on the uncoated side after 1 week, and at that stage rewound to give log rolls with a running length of 25 m. These log rolls are stored in an oven at 100° C. for 1 hour and then slit into rolls.

This winding film features balanced properties in flexibility, processability and hand tearability.

### EXAMPLE 5

Production takes place as in example 1, with the following changes:

the compound is composed of 72 phr of polymer A, 10 phr of RPT 200, 120 phr of Magnifin H 5 GV, 30 phr of Raven PFEB, 2 phr of Irganox 1010, 1.0 phr of Irganox PS 802 and 0.4 phr of Irgafos 168.

After one week's storage, the film is flame-pretreated on one side and coated at 80 g/m² (dry application) with Airflex EAF 60. The web is dried initially with an IR lamp and then to completion in a tunnel at 100° C. Subsequently the tape is wound up to form jumbo rolls (large rolls). In a further operation the jumbo rolls are unwound and the uncoated side of the winding film is subjected to weak corona treatment in a slitting machine for the purpose of increasing the unwind force, and is processed to give rolls 33 m long in a width of 19 mm on a 1½-inch core (37 mm inside diameter).

### EXAMPLE 6

Production takes place as in example 1, with the following changes:

the film contains 75 phr of polymer C, 20 phr of Escorene UL 00119, 5 phr of RPT 1800, 150 phr of Kisuma 5 A, 15 phr of Flammruβ 101, 0.8 phr of Irganox 1010, 0.8 phr of Irganox PS 802 and 0.3 phr of Irgafos 168.

This carrier film is corona treated on one side and stored for a week. The pretreated side is coated with 0.6 g/m² of an adhesion promoter layer comprising natural rubber, cyclo rubber and 4,4′-diisocyanatodiphenylmethane (solvent: toluene) and dried. The coating of adhesive mass is applied directly to the adhesion promoter layer using a comma bar with an application rate of 18 g/m² (based on solids). The adhesive mass is composed of a solution of a natural rubber adhesive mass in n-hexane with a solids content of 30 percent by weight. These solids are made up of 50 parts of natural rubber, 10 parts of zinc oxide, 3 parts of rosin, 6 parts of alkylphenolic resin, 17 parts of terpene-phenolic resin, 12 parts of poly-β-pinene resin, 1 part of Irganox 1076 antioxidant and 2 parts of mineral oil. This subsequent coat is dried in a drying tunnel at 100° C. Immediately downstream of this, the film is slit in a composite automatic slitter featuring a knife bar with sharp blades at a distance of 19 mm, to form rolls on standard adhesive-tape cores (3 inch).

Despite its high filler fraction, this winding film is distinguished by very high flexibility, which is reflected in a low force value at 1% elongation. This winding film has mechanical properties similar to those of plasticized PVC winding tapes, and is even superior in terms of flame retardancy and thermal stability. The holding power is 1500 min and the unwind force at 30 m/min (not 300 mm/min) is 5.0 N/cm. The fogging number is 62% (probably as a result of the mineral oil in the adhesive). Because of the large diameter of the roll, the roll can be pulled through only obliquely between winding board and cable harness, producing creases in the winding.

### EXAMPLE 7

The compounds for the individual layers of the film are produced without carbon black in a compounder with extruder and underwater granulation. The mixing time before homogenization is 2 minutes, while the total kneading time before discharge into the granulating extruder is 4 minutes. In the case of the compound for layers 2 and 3, half of the filler is added at the beginning and the other half after 1 minute. After drying, the granules of compound are mixed with the carbon black masterbatch in a concrete mixer and the mixture is supplied to a 3-layer coextrusion line in accordance with the casting process (die width 1400 mm, die-head melt temperature 190° C., chill-roll temperature 30° C., speed 30 m/min).

The make-up of the formula of the carrier film is as follows:

Layer 1:

μm: 100 phr of Evaflex P 1905, 40 phr of Magnifin H 5 GV, 20 phr of a masterbatch of 50% Flammruβ 101 and 50% polyethylene, 0.4 phr of Irganox 1076 and 0.2 phr of Irgafos 168

Layer 2:

40 μm: 70 phr of polymer B, 20 phr of Vinnapas B 100, 160 phr of Magnifin H 5 GV, phr of a masterbatch of 50% Flammruβ 101 and 50% polyethylene, 0.8 phr of Irganox 1076, 0.8 phr of Irganox PS 800 and 0.2 phr of Irgafos 168

Layer 3:

40 μm: as layer 2

Layer 4:

15 μm: 100 phr of Escorene UL 02133, 0.4 phr of Irganox 1076 and 0.2 phr of Irgafos 168

Layer 5:

20 μm: Levapren 450

Because of problems that occurred with the blown film, the film is heat-set. After a week of storage at 23° C. the film is coated as in example 1, but using the leveling rolls. The winding film thus obtained is wound into log rolls with a running length of 20 m, which are conditioned at 40° C. for one week. Slitting takes place by parting of the log rolls using a fixed blade (straight knife).

In a preliminary experiment a mixing time of 2 minutes was chosen; the film is homogeneous (no specks of filler) but the breakdown voltage is only 3 kV/100 μm. Therefore, in spite of the risk of degradation, the mixing time is increased (the melt index, as a measure of degradation, undergoes only an immaterial increase as a result of the longer time, owing to the use of phosphite stabilizer). This material has no bond strength for steel and adheres poorly to the reverse. This adhesion is enough to ensure that the turns do not shift relative to one another, but at the end of winding it is necessary to carry out final fastening with a pressure-sensitively adhesive winding film.

As a result of the conditioning, the unwind force rises to such a degree that the winding film can be applied under slight tension. This embodiment is solvent-free and easy to prepare, since no coating is required.

As a result of the colored layer 1, which comprises little flame retardant, the winding film exhibits virtually no stress whitening under high elongation. The fogging number is 97%.

Relative to the other inventive examples and to the comparative examples based on polyolefin and magnesium hydroxide, this film has the feature that, on elongation of more than 20%, no stress whitening is in evidence, since the outermost layer has only a low filler fraction, which is also attached effectively to the polar polymer. As a result of the presence of polar polymer, the fire performance is nevertheless excellent and the polypropylene-containing layer prevents melting of the film. Although the incompatible polymer is only present in the middle layers, the winding tape nevertheless shows good hand tearability.

Properties of the inventive examples

| | Example | Example | Example | Example | Example | Example | Example |
|---|---|---|---|---|---|---|---|
| | 1 | 2 | 3 | 4 | 5 | 6 | 7 |
| Film thickness [mm] | 0.085 | 0.08 | 0.095 | 0.08 | 0.06 | 0.09 | 0.11 |
| Bond strength steel [N/cm] | 3.0 | 2.8 | 3.3 | 2.4 | 2.0 | 4.0 | 1.7 |
| Bond strength to own reverse [N/cm] | 2.2 | 2.0 | 2.4 | 1.8 | 1.6 | 1.8 | 1.7 |
| Unwind force [N/cm] | 2.4 | 2.1 | 2.3 | 1.9 | 1.9 | 2.7 | 2.0 |
| Tensile strength* [N/cm] | 10.4 | 8.7 | 7.1 | 6.9 | 12.3 | 9.8 | 8.2 |
| Breaking elongation* [%] | 620 | 580 | 830 | 890 | 530 | 940 | 790 |
| Force at 1% elongation [N/cm] | 2.5 | 2.8 | 1.9 | 1.7 | 3.1 | 1.9 | 2.1 |
| Force at 100% elongation [N/cm] | 7.2 | 8.1 | 6.3 | 5.1 | 10.2 | 7.3 | 5.9 |
| Breaking elongation* after 20 d @ 136° C.[%] | 560 | 440 | 320 | 410 | 350 | 520 | 620 |
| Breaking elongation* after 3000 h @ | yes | yes | yes | yes | yes | yes | yes |
| 105° C. >100% | | | | | | | |
| Thermal stability 168 h @ 140° C. | yes | yes | yes | yes | yes | yes | yes |
| Heat resistance 30 min @ 170° C. | yes | yes | yes | yes | yes | yes | yes |
| Compatibility with PE and PP cables | no | no | no | no | no | no | no |
| 3000 h @ 105° C. | embrittle- | embrittle- | embrittle- | embrittle- | embrittle- | embrittle- | embrittle- |
| | ment | ment | ment | ment | ment | ment | ment |
| Compatibility with PE and PP cables | no | no | no | no | winding | no | no |
| 2000 h @ 125° C. | embrittle- | embrittle- | embrittle- | embrittle- | film | embrittle- | embrittle- |
| | ment | ment | ment | ment | brittle | ment | ment |
| Hand tearability | +++ | +++ | ++ | + | +++ | + | + |
| LOI [%] | 23.1 | 25.1 | 19.1 | 24.8 | 20.2 | 21.3 | 21.4 |
| Flame spread rate FMVSS 302 | 40 | self- | 263 | self- | 201 | 173 | 186 |
| [mm/min] | | extinguishing | | extinguishing | | | |
| Fogging number | 99 | 96 | 86 | 92 | 95 | 59 | 93 |
| Absence of halogen | yes | yes | yes | yes | yes | yes | yes |
| Phosphorus content >0.5 phr | yes | yes | yes | yes | yes | yes | yes |

*on specimens slit using blades

### COMPARATIVE EXAMPLE 1

Coating is carried out using a conventional film for insulating tape, from Singapore Plastic Products Pte, under the name F2104S. According to the manufacturer the film contains about 100 phr (parts per hundred resin) of suspension PVC with a K value of 63 to 65, 43 phr of DOP (di-2-ethylhexyl phthalate), 5 phr of tribasic lead sulfate (TLB, stabilizer), 25 phr of ground chalk (Bukit Batu Murah Malaysia with fatty acid coating), 1 phr of furnace black and 0.3 phr of stearic acid (lubricant). The nominal thickness is 100 μm and the surface is smooth but maft.

Applied to one side is the primer Y01 from Four Pillars Enterprise, Taiwan (analytically acrylate-modified SBR rubber in toluene) and atop that 23 g/m² of the adhesive IV9 from Four Pillars Enterprise, Taiwan (analytically determinable main component: SBR and natural rubber, terpene resin and alkylphenolic resin in toluene). Immediately downstream of the dryer, the film is slit to rolls in an automatic composite slitter having a knife bar with sharp blades at a distance of 25 mm.

The elongation at break after 3000 h at 105° C. cannot be measured, since as a result of plasticizer evaporation the specimen has disintegrated into small pieces. After 3000 h at 85° C. the breaking elongation is 150%.

### COMPARATIVE EXAMPLE 2

Example 4 of EP 1 097 976 A1 is reworked.

The following raw materials are compounded in a compounder: 80 phr of Cataloy KS-021 P, 20 phr of Evaflex P 1905, 100 phr of Magshizu N-3, 8 phr of Norvaexcel F-5 and 2 phr of Seast 3H, and the compound is granulated, but the mixing time is 2 minutes.

In a preliminary experiment it is found that with a mixing time of 4 minutes the melt index of the compound increases by 30% (which may be due to the absence of a phosphite stabilizer or to the greater mechanical degradation owing to the extremely low melt index of the polypropylene polymer). Although the filler was dried beforehand and a venting apparatus is located above the kneading compounder, a pungent phosphine odor is formed on the line during kneading.

The carrier film is subsequently produced by means of extrusion as described in example 7 (with all three extruders being fed with the same compound) via a slot die and chill roll in a thickness of 0.20 mm, the rotational speed of the extruder being reduced until the film reaches a speed of 2 m/min.

In a preliminary experiment it is not possible to achieve the speed of 30 m/min as in example 7, since the line shuts down owing to excess pressure (excessive viscosity). In a further preliminary experiment the film is manufactured at 10 m/min; the mechanical data in machine and cross directions pointed to a strong lengthwise orientation, which is confirmed in the course of coating by a 20% contraction in machine direction. The experiment is therefore repeated with an even lower speed, which gave a technically flawless (including absence of specks) but economically untenable film.

Coating takes place in the same way as in example 3, but with adhesive applied at 30 g/m² (the composition of this adhesive mass is similar to that of the original adhesive mass of the patent example reworked). Immediately downstream of the dryer, the film is divided into strips 25 mm wide, using a knife bar with sharp blades, and in the same operation is wound into rolls.

The self-adhesive winding tape is notable for a lack of flexibility. As compared with example 5 or 6, the rigidity of comparative example 2 is higher by 4030% or 19 000%, respectively.

As is known, the rigidity can be calculated easily from the thickness and the force at 1% elongation (proportional to the elasticity modulus). Because of the red phosphorus it contains, and because of the relatively high thickness, the specimen exhibits very good fire performance (note: the LOI value was measured on the 0.2 mm thick sample with adhesive, whereas the LOI of 30% in the cited patent originates from a 3 mm thick test specimen without adhesive).

### COMPARATIVE EXAMPLE 2a

The breakdown voltage of 2 kV/100 μm for comparative example 2 is too low for use as an insulating tape, in order to achieve an adequate absolute breakdown voltage at thicknesses which allow acceptable flexibility. The low breaking elongation points to inhomogeneities which, although beneficial to hand tearability, have an adverse effect on the breakdown voltage.

In a supplementary experiment, 2a, the compound is mixed more intensely. By this means an improvement is achieved in the breakdown voltage to 4 kV/100 μm, but in tandem with a deterioration in the hand tearability and an increase in the breaking elongation to 570%.

The examples of EP 1 097 976 A1 have a breaking elongation of the order of 300%, which generally points to poor mixing and hence low breaking elongation and low breakdown voltages.

### COMPARATIVE EXAMPLE 2b

In view of the technical problems that occurred an attempt is made to carry out manufacturing under conditions as in example 1, with a calender process, it having been found beforehand, by chance, that a low melt index is no problem in the case of the polypropylene polymer for the calender process, but instead is in fact an almost mandatory prerequisite.

Since the formula of example 4 of EP 1 097 976 A1 is inadequate in terms of mechanical properties, the formula from experiment 1 is processed: 80 phr of Cataloy KS-353 P, 20 phr of Evaflex P 702, 100 phr of Magshizu N-3, 8 phr of Norbaexcel F-5 and 2 phr of Seast 3H.

The mixture sticks to the calender rolls to such an extent that it is impossible to produce a film specimen. Therefore, first 0.2 phr of stearic acid is added, as a conventional lubricant, and in the absence of remedy 5 phr of Baerostab UBZ 639 (conventional calender additive package made up of stabilizer and lubricant, from Baerlocher) are added as well, but likewise fail to solve the processing problem.

The reason is regarded as lying in the large amount of EEA polymer, since EEA and EVA exhibit high specific adhesion to chromium and steel. As the skilled worker realizes, the problem could possibly be solved by a massive increase in the filler content; since, however, a compression molding 0.2 mm thick produced from the compound already appears too rigid, a film with a higher filler content would certainly have had no prospect of being sufficiently flexible.

### COMPARATIVE EXAMPLE 3

Example A of WO 97/05206 A1 is reworked.

The production of the compound is not described. The components are therefore mixed on a twin-screw laboratory extruder with a length of 50 cm and an L/D ratio of 1:10: 9.59 phr of Evatane 2805, 8.3 phr of Attane SL 4100, 82.28 phr of Evatane 1005 VN4, 74.3 phr of Martinal 99200-08, 1.27 phr of Irganox 1010, 0.71 phr of AMEO T, 3.75 phr of black masterbatch (prepared from 60% by weight of polyethylene with MFI=50 and 40% by weight of Furnace Seast 3H), 0.6 phr of stearic acid and 0.60 phr of Luwax AL 3.

The compound is granulated, dried and blown on a laboratory line to form a film bubble, which is slit both sides. An attempt is made to coat the film with adhesive after corona pretreatment, as in example 1; however, the film exhibits excessive contraction in the cross and machine directions, and because of excessive unwind force it is hardly still possible to unwind the rolls after 4 weeks.

This is therefore followed by an experiment at coating with an apolar rubber adhesive as in example 6, but this attempt fails because of the sensitivity of the film to solvent. Since the publication indicated does not describe coating with adhesive, but does describe adhesive properties that are to be aimed at, the film is slit up with shears between a set of pairs of two rotating knives each, to give strips 25 mm wide, which are wound.

The self-adhesive winding tape features good flexibility and flame retardancy. The hand tearability, however, is inadequate. A particular disadvantage, though, is the low heat distortion resistance, which leads to the adhesive tape melting when the aging tests are carried out. Moreover, the winding tape results in a considerable shortening of the lifetime of the cable insulation, as a result of embrittlement. The high contraction tendency is caused by the inadequate melt index of the compound. Even with a higher melt index of the raw materials, problems are likely, despite the fact that the contraction will become much lower as a result, since no heat-setting is envisaged in the stated publication, despite the low softening point of the film. Since the product exhibits no significant unwind force it is almost impossible to apply to wire bundles. The fogging number is 73% (probably owing to the paraffin wax).

### COMPARATIVE EXAMPLE 4

Example 1 of EP 0 953 599 A1 is reworked.

The preparation of the compound is mixed as described on a single-screw laboratory extruder: 85 phr of Lupolex 18 E FA, 6 phr of Escorene UL 00112, 9 phr of Tuftec M-1943, 63 phr of Magnifin H 5, 1.5 phr of magnesium stearate, 11 phr of Novaexcel F 5, 4 phr of Carbon Black FEF, 0.2 phr of Irganox 1010 and 0.2 phr of Tinuvin 622 LD, a marked release of phosphine being apparent from its odor.

Film production takes place as in comparative example 3.

The film, however, has a large number of specks of filler and has small holes, and the bubble tears a number of times during the experiment. The breakdown voltage varies widely from 0 to 3 kV/100μ. For further homogenization, therefore, the granules are melted again in the extruder and granulated. The compound now obtained has only a small number of specks. Coating and slitting take place as in example 1.

Through the use of red phosphorus, the self-adhesive winding tape features very good flame retardancy. Since the product has no unwind force, it is virtually impossible to apply to wire bundles. The heat stability is inadequate, owing to the low melting point.

### COMPARATIVE EXAMPLE 5

A UV-crosslinkable acrylate hotmelt adhesive of the type Acronal DS 3458 is applied by means of nozzle coating at 50 m/min to a textile carrier of the Maliwatt stitchbonded knit filament web type (80 g/m², 22 denier, black, thickness about 0.3 mm). The temperature load on the carrier is reduced by means of a cooled counterpressure roll. The application rate is about 65 g/m². Appropriate crosslinking is achieved in-line, upstream of the winding process, by irradiation with a UV unit equipped with 6 medium-pressure Hg lamps each of 120 W/cm. The bales are converted by shearing slitting (between a set of rotating blades slightly offset in pairs) to give rolls on standard 3-inch cores.

This winding tape features good adhesive properties and also very good compatibility with different cable insulation materials (PVC, PE, PP) and fluted tubes. From a performance standpoint, however, the high thickness and the absence of hand tearability are very disadvantageous.

### COMPARATIVE EXAMPLE 6

To produce the carrier film, 100 phr of polymer A, 150 phr of Magnifin H 5 GV, 10 phr of Flammruβ 101, 0.8 phr of Irganox 1010, 0.8 phr of Irganox PS 802 and 0.3 phr of Irgafos 168 are first compounded in a co-rotating twin-screw extruder. ⅓ of the Magnifin is added in each of zones 1, 3, and 5.

The compound melt is taken from the nozzle of the extruder to a roll mill, from which it is passed through a strainer and subsequently via a conveyor belt into the nip of a calender of the “Inverted L” type. With the aid of the calender rolls a film is formed with a smooth surface in a width of 1500 mm and a thickness of 0.08 mm (80 μm) and is post-crystallized on heat-setting rolls. The film is stored for a week, leveled on the coating unit with rolls at 60° C. in order to improve the planar lie, subjected to corona treatment and then coated with an aqueous acrylate PSA, Primal PS 83 D, with a coatweight of 24 g/m², using a coating knife. The layer of adhesive is dried in a drying tunnel at 70° C. and the ready-produced winding film is wound up to form log rolls with a running length of 33 m on a 1-inch core (25 mm). Slitting is performed by parting the log rolls using a fixed blade with a not very acute angle (straight knife), to form rolls 29 mm wide. As in the case of the subsequent examples too, parting slitting is carried out using an automatic unit, for the reasons set out in the description of the invention.

Despite the high filler fraction, this self-adhesive winding film exhibits good flexibility. The aging stability and the compatibility with PP and PA cables and polyamide fluted tube are outstanding. In application tests, inadequate hand tearability became apparent in manual processing.

### COMPARATIVE EXAMPLE 7

Example 1 of WO 00/71634 A1 is reworked.

The following mixture is produced in a compounder: 80,8 phr of ESI DE 200, 19.2 phr of Adflex KS 359 P, 30.4 phr of calcium carbonate masterbatch SH3, 4.9 phr of Petrothene PM 92049, 8.8 phr of antimony oxide TMS and 17.6 phr of DE 83-R.

The compound is processed to flat film on a laboratory casting line, corona-pretreated, coated at 20 g/m² with JB 720, wound into log rolls with a 3-inch core, and slit by parting with a fixed blade (advanced by hand).

This winding tape features PVC-like mechanical behavior: that is, high flexibility and good hand tearability. A disadvantage is the use of brominated flame retardants. Moreover, the heat distortion resistance at temperatures above 95° C. is low, so that the film melts during the aging and compatibility tests.

Properties of the comparative examples

| | Comp. ex. | Comp. ex. | Comp. ex. | Comp. ex. | Comp. ex. | Comp. ex. | Comp. ex. |
|---|---|---|---|---|---|---|---|
| | 1 | 2 | 3 | 4 | 5 | 6 | 7 |
| Film thickness [mm] | 0.08 | 0.20 | 0.15 | 0.20 | 0.29 | 0.08 | 0.125 |
| Bond strength steel [N/cm] | 1.8 | 3.3 | 2.0 | 1.9 | 5.1 | 2.9 | 2.3 |
| Bond strength to own reverse [N/cm] | 1.6 | 1.5 | 1.8 | 1.4 | 1.5 | 1.9 | 1.2 |
| Unwind force [N/cm] | 2.0 | 1.8 | 1.9 | 1.7 | 3.5 | 2.2 | 1.5 |
| Tensile strength* [N/cm] | 15 | 10.9 | 22.3 | 44.0 | 51.3 | 10.2 | 22.5 |
| Breaking elongation* [%] | 150 | 370 | 92 | 720 | 72 | 760 | 550 |
| Force at 1% elongation [N/cm] | 1.0 | 11.4 | 4.3 | 5.9 | 5.2 | 2.1 | 0.46 |
| Force at 100% elongation [N/cm] | 14.0 | 9.2 | — | 19.8 | — | 5.7 | 6.3 |
| Breaking elongation* after 20 d @ 136° C. [%] | embrittled | embrittled | melted | melted | 60 | 380 | melted |
| Breaking elongation* after 3000 h @ | embrittled | embrittled | yes | yes | not | yes | embrittled |
| 105° C. >100% | | | | | embrittled | | |
| Compatibility with PE and PP cables | no | PE yes | cable | tape | yes | yes | tape |
| 3000 h @ 105° C. | | PP no | embrittled | fragile | | | fragile |
| Thermal stability 168 h @ 140° C. | no | yes | no | no | yes | yes | no |
| Heat stability 30 min @ 170° C. | no | yes | no | no | yes | yes | no |
| Compatibility with PE and PP cables | no | no | tape | tape | yes | yes | tape |
| 2000 h @ 125° C. | | | melted | melted | | | melted |
| Hand tearability | +++ | − | − | − | − | + | + |
| LOI [%] | 21.4 | 27.1 | 19.3 | 28.3 | 20.5 | 22.1 | 32.6 |
| Flame spread rate FMVSS 302 | 324 | self- | 463 | self- | 362 | 51 | self- |
| [mm/min] | | extinguishing | | extinguishing | | | extinguishing |
| Fogging number | 29 | 66 | 73 | 63 | 99 | 95 | 73 |
| Absence of halogen | no | yes | yes | yes | yes | yes | no |
| Phosphorus content <0.5 phr | yes | no | yes | no | yes | yes | yes |

*on specimens slit using blades

1. A flame-retardant, halogen-free winding film comprising
at least one polypropylene copolymer,
at least one inorganic flame retardant, and
1 to 30 phr, of at least one polymer which is incompatible with the polypropylene copolymer.

2. The winding film of claim 1, wherein the polymers which are incompatible with the polypropylene contain at least 25% by weight of oxygen.

3. The winding film of claim 1, wherein the solubility parameter σ of the incompatible polymers is at least 19 J^{1/2} cm^{1/2}.

4. The winding film of claim 1, wherein the incompatible polymer is polyvinyl acetate or is composed of a polyester or a polyamide.

5. The winding film of claim 1, wherein the inorganic flame-retardant is a magnesium hydroxide and is present in an amount of 70 to 200 phr.

6. The winding film of claim 1, wherein the winding film comprises an adhesive coating and the oxygen index (LOI) of the adhesive-coated winding film is at least 19%, and the flame spread rate in accordance with FMVSS 302 is less than 300 mm/min.

7. The winding film of claim 1, wherein the winding film comprises not only the polypropylene copolymer but also ethylene-propylene copolymers selected from the group consisting of the EPM and EPDM polymers.

8. The winding film of claim 1, wherein the winding film contains at least 5 phr.

9. The winding film of claim 1, wherein the polypropylene copolymer has a flexural modulus of less than 500 MPa, and/or a crystallite melting point in the range from 120° C. to 166° C.

10. The winding film of claim 1, wherein the thickness of the winding film is 50 to 150 μm, and the force in machine direction at 1% elongation is 1 to 4 N/cm and/or the force at 100% elongation is 3 to 15 N/cm.

11. The winding film of claim 1, wherein the winding film has on one or both sides a self-adhesive layer, which is preferably optionally based on polyisoprene, ethylene-vinyl acetate copolymer and/or polyacrylate, and optionally has a primer layer between film and adhesive layer, the amount of the adhesive layer being in each case 10 to 40 g/m² and the bond strength to steel being 1.5 to 3 N/cm.

12. The winding film of claim 1, wherein the winding film comprises a solvent-free pressure-sensitive adhesive which is produced by coextrusion, melt coating or dispersion coating, said pressure-sensitive adhesive being joined to the surface of the carrier film by means of flame or corona pretreatment or of an adhesion promoter layer which is applied by coextrusion or coating.

13. The winding film of claim 1, wherein the winding film is plasticizer-free or the plasticizer content is sufficiently low to produce a fogging number which is above 90%.

14. A method for bundling, protecting, labeling, insulating or sealing ventilation pipes or wires or cables and for sheathing cable harnesses in vehicles or field coils for picture tubes which comprises bundling, protecting, labeling, insulating or sealing said ventilation pipes or wires or cables sheathing said cable harnesses in vehicles or field coils for picture tubes with the winding film of claim 1.

15. The winding film of claim 8, wherein said carbon black has a pH of 6 to 8.

16. The winding film of claim 12, wherein said pressure-sensitive adhesive is a pressure-sensitive dispersion adhesive based on polyacrylate.
